(19) United States
(12) Patent Application Publication
(10) Pub. No.: US 2007/0106588 A1
(43) Pub. Date: May 10, 2007

(54) Method and system for funding a contingent event with convertible securities

(76) Inventor: Kevin Kulak, Darien, CT (US)

Correspondence Address: MILBANK, TWEED, HADLEY & MCCLOY, 1 CHASE MANHATTAN PLAZA, NEW YORK, NY, 10005-1413, US

(21) Appl. No.: 11/270,164

(22) Filed: Nov. 9, 2005

(51) Int. Cl. G06Q 40/00

(52) U.S. Cl. 705/36 R

(57) ABSTRACT

A system and method for funding a contingent event with convertible securities comprise obtaining a commitment from at least one investor to purchase shares of convertible securities, and enforcing the commitment within a first predetermined period by selling the shares of convertible securities to the investors. The shares of convertible securities comprise a provision to redeem the convertible securities from the investors if within the first predetermined period the contingent event has not occurred.

The invention relates to the field of financing and more particularly to the field of contingent financing and convertible markets.

### BACKGROUND

Companies frequently require bridge or longer-term funding to support a contingent event, such as an acquisition or merger. Systems and methods are needed to provide such funding using non-traditional sources.

The preceding description is not to be construed as an admission that any of the description is prior art relative to the present invention.

### SUMMARY OF THE INVENTION

In various aspects, the invention provides a system and method for funding a contingent event with convertible securities. The system and method comprise obtaining a commitment from at least one investor to purchase shares of convertible securities, and enforcing the commitment within a first predetermined period by selling the shares of convertible securities to the investors. The shares of convertible securities comprise a provision to redeem the convertible securities from the investors if within the first predetermined period the contingent event has not occurred.

In one aspect, the shares of convertible securities further comprise a provision to redeem the convertible securities from the investors after a second predetermined period if the contingent event has occurred. In one aspect, the provision to redeem the convertible securities from the investors after a second predetermined period if the contingent event has occurred further provides a price substantially equal to a liquidation preference. In one aspect, the commitment further comprises a provision to cancel the commitment if trading price of common stock of a company issuing the convertible securities declines below a predetermined threshold. In one aspect, the predetermined threshold is approximately 10% below the trading price of the common stock at the time of the commitment. In one aspect, the provision to redeem the convertible securities from the investors if within the first predetermined period the contingent event has not occurred further comprises providing a price substantially equal to a liquidation preference plus a percentage of an increase in a conversion value. In one aspect, selling the shares of convertible securities to the investors is a private placement under Rule 144A. In one aspect, selling the shares of convertible securities to the investors is a public placement. In one aspect, the shares of convertible securities further comprise a provision for converting the convertible securities to common stock of a company issuing the convertible securities. In one aspect, the convertible securities are preferred. In one aspect, the convertible securities are perpetual. In one aspect, the contingent event is an acquisition. In one aspect, the contingent event is a merger. In one aspect, the first predetermined period of time is substantially equal to one year. In one aspect, the second predetermined period of time is substantially equal to seven years. In one aspect, the shares of convertible securities further comprise a conversion premium determined at the time of the commitment. In one aspect, the conversion premium is based on price of common stock of a company selling the convertible security, which price is determined at the time the commitment is enforced.

In other various aspects, the invention provides a financing commitment agreement. The agreement comprises a provision whereby an investor agrees to purchase shares of convertible securities within a first predetermined period, and a provision for an issuer to redeem the convertible securities from the investors if within the first predetermined period a contingent event has not occurred.

In one aspect, the shares of convertible securities further comprise a provision to redeem the convertible securities from the investors after a second predetermined time if the contingent event has occurred. In one aspect, the provision to redeem the convertible securities from the investors after a second predetermined time if the contingent event has occurred further provides a price substantially equal to a liquidation preference. In one aspect, the system and method further comprise a provision to cancel the commitment if trading price of common stock of a company issuing the convertible securities declines below a predetermined threshold. In one aspect, the predetermined threshold is approximately 10% below the trading price of the common stock at the time of the commitment. In one aspect, the provision to redeem the convertible securities from the investors if within the first predetermined period the contingent event has not occurred further comprises providing a price substantially equal to a liquidation preference plus a percentage of an increase in a conversion value. In one aspect, purchase of the shares of convertible securities by the investors is a private placement under Rule 144A. In one aspect, purchase of the shares of convertible securities by the investors is a public placement. In one aspect, the shares of convertible securities further comprise a provision for converting the convertible securities to common stock of a company issuing the convertible securities. In one aspect, the convertible securities are preferred. In one aspect, the convertible securities are perpetual. In one aspect, the contingent event is an acquisition. In one aspect, the contingent event is a merger. In one aspect, the first predetermined period of time is substantially equal to one year. In one aspect, the second predetermined period of time is substantially equal to seven years. In one aspect, the shares of convertible securities further comprise a conversion premium determined at the time of the commitment. In one aspect, the conversion premium is based on price of common stock of a company selling the convertible security, which price is determined at the time the commitment is enforced.

The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an example system according to one embodiment; and

FIG. 2 illustrates steps in an example method according to one embodiment.

It is understood that the drawings are for illustration only and are not limiting.

### DETAILED DESCRIPTION OF THE DRAWINGS

The embodiments described below allow a company to secure a commitment agreement from investors to purchase convertible securities. Funds from sale of the convertible securities are used to fund a contingent event, such as an acquisition or merger. At any time during the commitment period, which is typically about one year, the issuer may put the convertible securities to the investors. If the issuer puts the securities to the investors and the contingent event does not occur, the issuer may redeem the securities. If the contingent event occurs and the issuer does not put the securities, the investors may enforce the commitment and purchase or call the convertible securities from the issuer. The issuer also has the option to cancel the commitment if the company common stock trading price declines below a threshold, or other contingencies occur.

An Example System

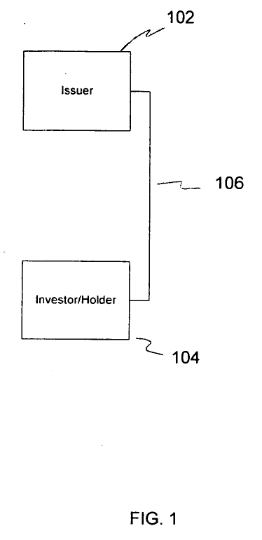

Referring to FIG. 1, an example system 100 according to an embodiment includes issuer 102 and investors/holders 104, interconnected by network 106. Although not illustrated, issuer 102 and investor/holder 104 include computers with central processor units, memory (RAM, ROM, etc.), fixed and removable code storage devices (hard drives, floppy drives, CD, DVD, memory stick, etc.), input/output devices (keyboards, display monitors, printers, pointing devices, etc.), and network interconnect devices (Ethernet cards, WiFi cards, modems, etc.). Network 106 (LAN, WAN, extranet, the Internet, PSTN, etc.) is used to exchange electronic communications between issuer 102 and investor/holder 104 using information signals. Software code to accomplish the methods described may be stored on a computer-readable medium and may also be transmitted as an information signal, such as for download.

An Example Method

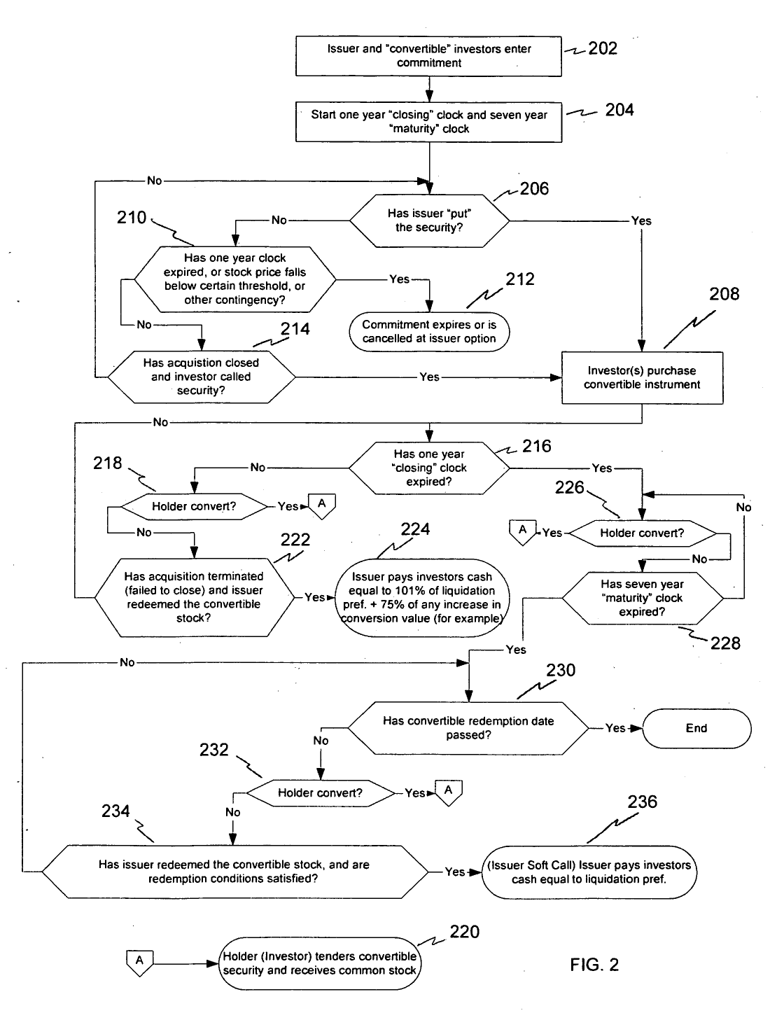

Referring to FIG. 2, an example embodiment begins at step 202 with issuer 102 and investors/holders 104 entering into a commitment. Under the terms of the commitment, issuer 102 agrees to sell and investors/holders agree to purchase shares of convertible securities for a specific period of time, such as one year, if the issuer puts or enforces the commitment. Proceeds from the sale of the securities are intended for use in financing a contingent event, such as an acquisition or merger. The commitment fixes the coupon (e.g., 5.75%) and the conversion premium based on common stock price (e.g., 20% above closing stock price on date of issuance). The conversion price can be calculated using the common stock price at the time of issuance, which helps to reduce hedging activity, or the conversion price can be calculated at some future date. Issuer 102 has the right under the commitment to put the securities at any time within the year whether the contingent event has occurred. Investors/holders have the right under the commitment to call the securities within the year only if the contingent event occurs. Issuer 102 has the right to cancel the commitment if the common stock price of the issuer declines below a predetermined threshold, such as a 10% decline, or approximately that amount. Issuer 102 may also have the right to cancel the commitment if other contingent events occur. Issuer 102 also has a traditional call right whereby after a predetermined time (e.g., 7 years), and up to but excluding the redemption date, issuer 102 may redeem the securities at a redemption price equal to the liquidation preference. Issuer 102's call right may be subject to certain contingent events, such as the last reported sale price of the common stock exceeding a certain percentage of the conversion price (e.g., 140%), for at least 20 trading days of the 30 consecutive trading days ending on the trading day prior to the date upon which the issuer delivers the notice of redemption.

At step 204, a one year closing clock starts, along with a seven year maturity clock, for example.

At step 206, system 100 determines whether issuer 102 has put the securities, and if so, then at step 208 investors/holders 104 purchase the securities.

If at step 206, system 100 determines that issuer 102 has not put the security, then at step 210, system 100 determines whether the one year closing clock has expired, and if so, the commitment expires at step 212 without being exercised. At step 210, system 100 also determines whether the stock price has fallen below the predetermined threshold, such as a 10% decline or other contingencies, and if the price has declined, issuer 102 has the option to cancel the commitment at step 212. System 100 also determines at step 212 whether any other contingencies have occurred that would allow cancellation of the commitment.

If at step 210 system 100 determines that the one year closing clock has not expired and issuer 102 has not cancelled the commitment, then at step 214, system 100 determines whether the contingent event has occurred, and whether investor/holder 104 has called the security. If so, then at step 208 investors/holders 104 purchase the security. If not, system 100 loops to step 206.

If investors/holders 104 have purchased the securities at step 208, because the issuer put the securities or the investors called the securities, then at step 216 system 100 determines whether the one year closing clock has expired. If it has not expired, then at step 218, system 100 determines whether holders/investors 104 have converted, and if so, at step 220 holders/investors 104 tender the convertible security and receive common stock.

If at step 218 system 100 determines that holders/investors 104 have not converted, then at step 222 system 100 determines whether the contingent event (e.g., the acquisition or merger) has terminated (failed to close) and whether the issuer has redeemed the security. If not, system 100 loops to step 216. If so, then at step 224 issuer 102 pays investors/holders 104 cash equal to 101% of the liquidation preference plus 75% of any increase in the conversion value (for example).

If at step 216, system 100 determines that the one year closing clock has expired, then at step 226 system 100 determines whether holders/investors 104 have converted, and if so, at step 220 holders/investors 104 tender the convertible security and receive common stock.

If at step 226 system 100 determines that holders/investors 104 have not converted, then at step 228 system 100 determines whether the seven year maturity clock has expired, and if not loops to step 226.

If at step 228, system 100 determines that the seven year maturity clock has expired, then at step 230, system 100 determines whether the convertible redemption date has passed. If so, the method ends. If not, then at step 232 system 100 determines whether holders/investors 104 have converted, and if so, at step 220 holders/investors 104 tender the convertible security and receive common stock.

If at step 232 system 100 determines that holders/investors 104 have not converted, then at step 234 system 100 determines whether issuer 102 has redeemed the security and whether the redemption conditions are satisfied. If not, system 100 loops to step 230. If so, then at step 236, issuer 102 pays investors/holders 104 cash equal to the liquidation preference.

In one embodiment, the convertible securities are perpetual. In one embodiment, the convertible securities are preferred. In one embodiment, selling the shares of convertible securities to the investors is a private placement under Rule 144A. In one embodiment, selling the shares of convertible securities to the investors is a public placement.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method for funding a contingent event with convertible securities, the method comprising:
obtaining a commitment from at least one investor to purchase shares of convertible securities; and
enforcing the commitment within a first predetermined period by selling the shares of convertible securities to the investors, wherein the shares of convertible securities comprise a provision to redeem the convertible securities from the investors if within the first predetermined period the contingent event has not occurred.

2. A method according to claim 1, wherein the shares of convertible securities further comprise a provision to redeem the convertible securities from the investors after a second predetermined period if the contingent event has occurred.

3. A method according to claim 2, wherein the provision to redeem the convertible securities from the investors after a second predetermined period if the contingent event has occurred further provides a price substantially equal to a liquidation preference.

4. A method according to claim 1, wherein the commitment further comprises a provision to cancel the commitment if trading price of common stock of a company issuing the convertible securities declines below a predetermined threshold.

5. A method according to claim 4, wherein the predetermined threshold is approximately 10% below the trading price of the common stock at the time of the commitment.

6. A method according to claim 1, wherein the provision to redeem the convertible securities from the investors if within the first predetermined period the contingent event has not occurred further comprises providing a price substantially equal to a liquidation preference plus a percentage of an increase in a conversion value.

7. A method according to claim 1, wherein selling the shares of convertible securities to the investors is a private placement under Rule 144A.

8. A method according to claim 1, wherein selling the shares of convertible securities to the investors is a public placement.

9. A method according to claim 1, wherein the shares of convertible securities further comprise a provision for converting the convertible securities to common stock of a company issuing the convertible securities.

10. A method according to claim 1, wherein the convertible securities are preferred.

11. A method according to claim 1, wherein the convertible securities are perpetual.

12. A method according to claim 1, wherein the contingent event is an acquisition.

13. A method according to claim 1, wherein the contingent event is a merger.

14. A method according to claim 1, wherein the first predetermined period of time is substantially equal to one year.

15. A method according to claim 1, wherein the second predetermined period of time is substantially equal to seven years.

16. A method according to claim 1, wherein the shares of convertible securities further comprise a conversion premium determined at the time of the commitment.

17. A method according to claim 16, wherein the conversion premium is based on price of common stock of a company selling the convertible security, which price is determined at the time the commitment is enforced.

18. A financing commitment agreement comprising:
a provision whereby an investor agrees to purchase shares of convertible securities within a first predetermined period; and
a provision for an issuer to redeem the convertible securities from the investors if within the first predetermined period a contingent event has not occurred.

19. A financing commitment according to claim 18, wherein the shares of convertible securities further comprise a provision to redeem the convertible securities from the investors after a second predetermined time if the contingent event has occurred.

20. A financing commitment according to claim 19, wherein the provision to redeem the convertible securities from the investors after a second predetermined time if the contingent event has occurred further provides a price substantially equal to a liquidation preference.

21. A financing commitment according to claim 18, further comprising a provision to cancel the commitment if trading price of common stock of a company issuing the convertible securities declines below a predetermined threshold.

22. A financing commitment according to claim 21, wherein the predetermined threshold is approximately 10% below the trading price of the common stock at the time of the commitment.

23. A financing commitment according to claim 18, wherein the provision to redeem the convertible securities from the investors if within the first predetermined period the contingent event has not occurred further comprises providing a price substantially equal to a liquidation preference plus a percentage of an increase in a conversion value.

24. A financing commitment according to claim 18, wherein purchase of the shares of convertible securities by the investors is a private placement under Rule 144A.

25. A financing commitment according to claim 18, wherein purchase of the shares of convertible securities by the investors is a public placement.

26. A financing commitment according to claim 18, wherein the shares of convertible securities further comprise a provision for converting the convertible securities to common stock of a company issuing the convertible securities.

27. A financing commitment according to claim 18, wherein the convertible securities are preferred.

28. A financing commitment according to claim 18, wherein the convertible securities are perpetual.

29. A financing commitment according to claim 18, wherein the contingent event is an acquisition.

30. A financing commitment according to claim 18, wherein the contingent event is a merger.

31. A financing commitment according to claim 18, wherein the first predetermined period of time is substantially equal to one year.

32. A financing commitment according to claim 18, wherein the second predetermined period of time is substantially equal to seven years.

33. A financing commitment according to claim 18, wherein the shares of convertible securities further comprise a conversion premium determined at the time of the commitment.

34. A financing commitment according to claim 33, wherein the conversion premium is based on price of common stock of a company selling the convertible security, which price is determined at the time the commitment is enforced.

35. A system for funding a contingent event with convertible securities, comprising:
means for obtaining a commitment from at least one investor to purchase shares of convertible securities; and
means for enforcing the commitment within a first predetermined period by selling the shares of convertible securities to the investors, wherein the shares of convertible securities comprise a provision to redeem the convertible securities from the investors if within the first predetermined period the contingent event has not occurred.

36. A computer-readable medium having computer executable software code stored thereon, the code for funding a contingent event with convertible securities, the code comprising:
code to obtain a commitment from at least one investor to purchase shares of convertible securities; and
code to enforce the commitment within a first predetermined period by selling the shares of convertible securities to the investors, wherein the shares of convertible securities comprise a provision to redeem the convertible securities from the investors if within the first predetermined period the contingent event has not occurred.

37. Computer executable software code transmitted as an information signal, the code for funding a contingent event with convertible securities, the code comprising:
code to obtain a commitment from at least one investor to purchase shares of convertible securities; and
code to enforce the commitment within a first predetermined period by selling the shares of convertible securities to the investors, wherein the shares of convertible securities comprise a provision to redeem the convertible securities from the investors if within the first predetermined period the contingent event has not occurred.

38. A programmed computer for funding a contingent event with convertible securities, comprising:
a memory having at least one region for storing computer executable program code; and
a processor for executing the program code stored in the memory, wherein the program code comprises:
code to obtain a commitment from at least one investor to purchase shares of convertible securities; and
code to enforce the commitment within a first predetermined period by selling the shares of convertible securities to the investors, wherein the shares of convertible securities comprise a provision to redeem the convertible securities from the investors if within the first predetermined period the contingent event has not occurred.
